(19) United States
(12) Patent Application Publication
(10) Pub. No.: US 2012/0100903 A1
(43) Pub. Date: Apr. 26, 2012

(54) ONLINE CARD GAME USING CARD DISPENSING MACHINE

(76) Inventor: Dai Won Kwon, Busan-si (KR)

(21) Appl. No.: 13/300,455

(22) Filed: Nov. 18, 2011

Related U.S. Application Data
(63) Continuation-in-part of application No. 13/320,525, filed on Nov. 14, 2011.

(30) Foreign Application Priority Data
May 12, 2009 (KR) 10-2009-0041127

(51) Int. Cl. A63F 13/00

(52) U.S. Cl. 463/16

(57) ABSTRACT

A card game machine enables players to play a card game using cards, each of which has a distinctive surface and a non-distinctive surface. The card game apparatus includes a card slide housing, a card stop unit, a card drive unit and a card receive unit. The card slide housing has sliders, each of which is inclined such that cards and slide down. The card stop unit is coupled to the card slide housing to temporarily stop cards. The card drive unit causes the stopped cards to start sliding again. The card receive unit is arranged below the card stop unit and has a plurality of card receiving parts corresponding to the respective sliders to receive cards. The card receiving parts are movable such that portions of the distinctive surfaces of the cards received in each receiving part are spaced apart from each other in one direction.

### RELATED APPLICATIONS

This application is a continuation-in-part application of U.S. patent application Ser. No. 13/320525 filed Nov. 14, 2011 which is a national phase application under 35 U.S.C. §371 of International Application No. PCT/KR2010/002792, filed May 3, 2010, designating the United States. This application further claims the benefit of the earlier filing dates under 35 U.S.C. §365(b) of Korean Patent Application No. 10-2009-0041127 filed May 12, 2009. This application incorporates herein by reference the disclosures of U.S. patent application Ser. No. 13/320525, International Application No. PCT/KR2010/002792 and Korean Patent Application No. 10-2009-0041127 in their entirety.

### BACKGROUND

1. Field

The present disclosure relates to an online game using a card game machine.

2. Related Technology

Playing cards such as Hwatu cards (Korean traditional play cards), trump cards etc. are widely used in various games. Card game machines with which card games can be played without card dealer are disclosed in Japanese patent application publication 2008-12157, 2005-103243 and Korean patent application publication 2006-93694.

In the card game machines disclosed in the above publications, when plural cards supplied to players are stacked on a card table, distinctive surfaces of lower cards are covered by upper cards except a card at the top of a stack of cards. In the game where the distinctive information of all the stacked cards is used to play games, players need to memorize the distinctive information of the lower cards, so it is very inconvenient to play games with the card game machines. For example, in a card game machine illustrated in FIG. 8, trump cards are stacked on a card table disposed below sliders, so that players can see distinctive information of a card only until another card slides down the slider to cover the distinctive information of a lower card.

The foregoing background section is to provide background information, and does not constitute an admission of prior art.

### SUMMARY

The prior card game machines distributing cards without a card dealer have problems that players cannot see the distinctive information of all cards distributed by the machines during a card game. The problems make it hard to enjoy the game.

It is an aspect of the present invention to provide a card game machine that can distribute cards without a card dealer. And the machine can distribute cards in a state that the distinctive information of cards can be seen by players during a card game.

One aspect provides a method of providing an online card game service, the method comprising: providing a card dispenser configured to dispense a plurality of cards to a card placing station and maintain the a plurality of cards in the card placing station, wherein each of the cards comprises a distinctive surface comprising at least one mark configured to make it distinctive from the other cards; operating the card dispenser to dispense a first one of the plurality of cards to the card placing station and maintain the first card in the card placing station; shooting video frames of the card dispenser in operation thereby generating video signals; streaming, by an online game server, the video signals to a user's terminal connected to the online game server thorough a network so as to display the video frames of the card dispenser in operation; sensing the at least one mark of the first card to identify the first card and generate information associated to the first card; and transmitting, by the online game server, the information to the user's terminal so as to display an image representing the first card on the user's terminal while the user's terminal displays the card dispenser.

In the foregoing method, the information may comprise image data representing the first card. The information may be configured to cause the user's terminal to process image data stored in the user's computer so as to display the image representing the first card on the user's computer. The information may be configured to cause the user's terminal to display the image representing the first card on the user's computer while the dispenser is dispensing the first card to the card placing station. The information may be configured to cause the user's terminal to display the image representing the first card on the user's computer while the dispenser maintaining the first card in the card placing station. The at least a mark may comprise one selected from the group consisting of characters, numbers, symbols, drawings and photos. The first card may be sensed during dispensing the first card or after dispensing the first card to the card placing station.

One aspect of the invention provides a method for playing a card game remotely using a system comprising a card game machine having a card distribute unit which distributes cards onto a plurality of sliders, a sensor for taking distinctive information images of distributed cards, a signal processor for producing an image recognition signal including the distinct information of cards and transmitting the image recognition signal, a card stop unit to stop cards from sliding down each of the sliders at a predetermined position, and a card drive unit which causes the cards that have been stopped by the card stop unit to start sliding again down the sliders in a flipped over state; a streaming server connected to the internet for transmitting video images of the operation state of the game machine in a streaming fashion; an application server connected to the internet for receiving the image recognition signal from the signal processor of the game machine and transmitting the image recognition signal; user terminals receiving the video images of the operation state of the game machine form the streaming server and the image recognition signal from the application server, displaying the video image and graphical images of cards; wherein the method comprises, transmitting the video images of the operation state of the game machine from the streaming server to the user terminals live in real time; transmitting the image recognition signal of a card from the application server to the user terminals, after the card being flipped over by the card drive unit and sliding again down a slider; displaying the video images of the operation state of the game machine and the graphical image of the card on the user terminals.

According to embodiments of the present invention, a card game machine for playing a card game with a plurality of cards, each of which has a distinctive surface and a non-distinctive surface, the card game machine comprising: a card slide housing having a plurality of sliders, each of which is inclined with respect to the vertical direction such that cards can slide down each of the sliders, and which are separated from each other; a card stop unit which is coupled to the card slide housing to stop cards from sliding down each of the sliders at a predetermined position; a card distribute unit which distributes cards onto each of the sliders; a card drive unit which causes the cards that have been stopped by the card stop unit to start sliding again down the sliders on which they have stopped; and a card receive unit which is arranged below the card stop unit and which has a plurality of card receiving parts corresponding to the respective sliders to receive the plurality of cards which have slid down the respective sliders, wherein said plurality of card receiving parts are movable such that portions of the distinctive surfaces of the cards received in each receiving part are spaced apart from each other in one direction is provided

The card game machine of embodiments of the present invention enables players to play a game without a card dealer, and enables distinctive information of each of the cards to be exposed always.

### BRIEF DESCRIPTION OF THE DRAWINGS

FIG. 1 is a perspective view of an embodiment of a card game machine according to embodiments of the present invention.

FIG. 2 is a partial front view of the card slide housing illustrated in FIG. 1.

FIG. 3 is a cross-sectional diagram along line of FIG. 2.

FIG. 4 illustrates the card receive unit in FIG. 2 in which a plurality of cards are stacked in a state that a portion of distinctive surface of each of cards is recognizable.

FIG. 5 is a partial front view of a card slide housing of another embodiment of a card game machine according to embodiments of the present invention.

FIG. 6 illustrates a card receive unit of another embodiment of a card game machine according to embodiments of the present invention in which cards are separated apart from each other to reveal the distinctive surfaces of the cards.

FIG. 7 is a cross-sectional diagram along line VII-VII of FIG. 6.

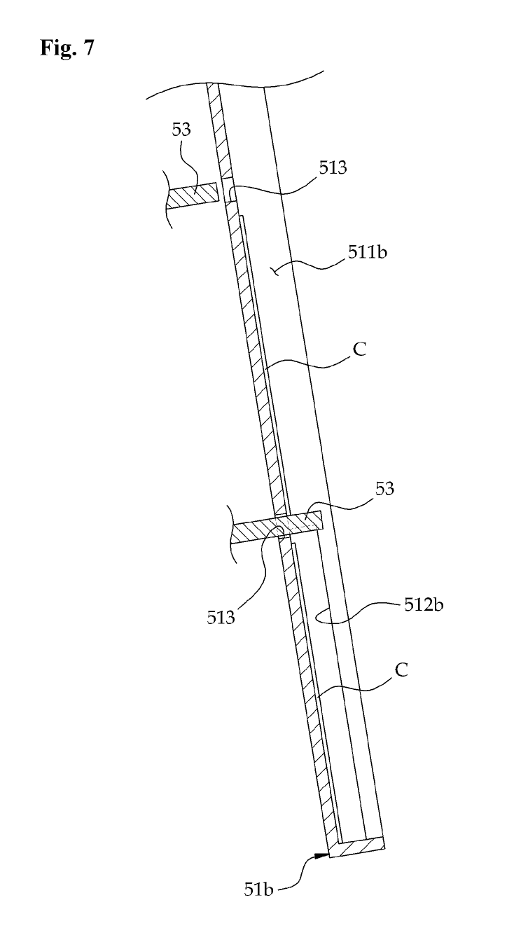

FIG. 8 is a perspective view of a prior art of a card game machine.

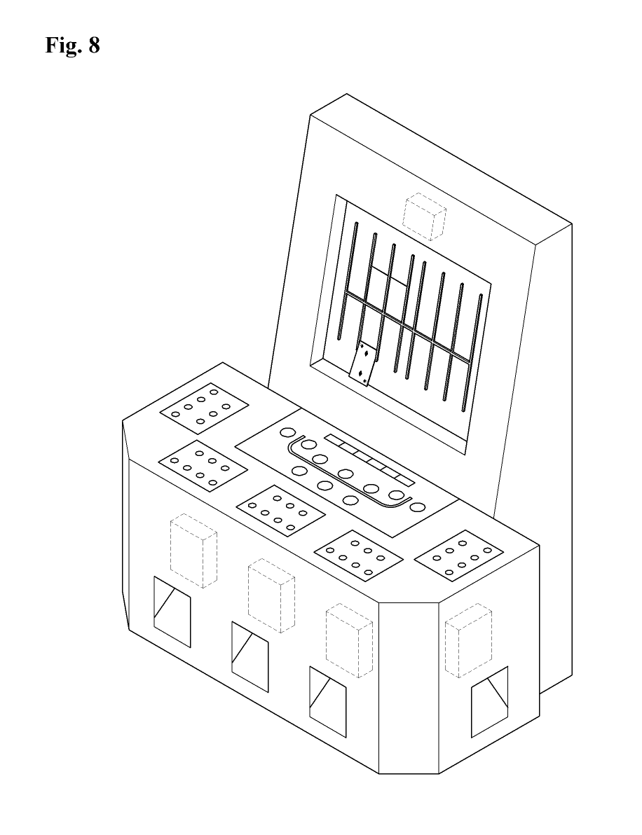

FIG. 9 shows configuration of a remote game system according to embodiments of the present invention.

FIG. 10 shows configurations of a game machine and a management server.

FIG. 11 shows a signal flow of a remote game system according to embodiments of the present invention.

FIG. 12 shows a Blackjack game machine.

FIG. 13 shows a screen of Blackjack game.

### DETAILED DESCRITPION OF EMBODIMENTS

Various embodiments of the present invention will now be described in more detail with reference to the accompanying drawings. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the drawings, can be arranged, substituted, combined, and designed in a wide variety of different configurations, all of which are explicitly contemplated and make part of this disclosure.

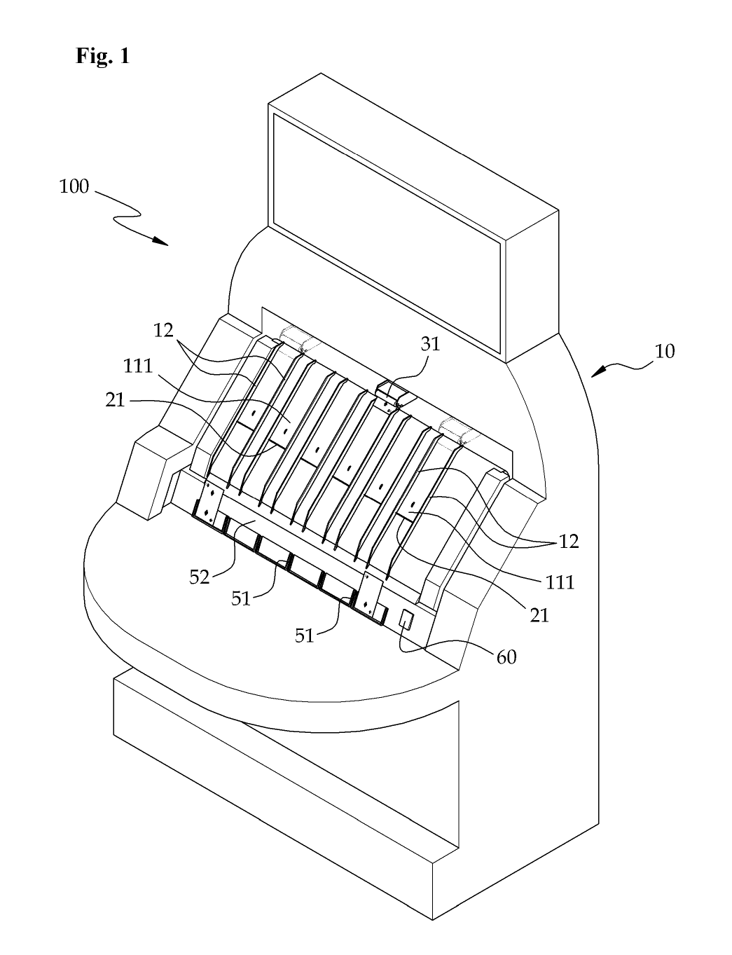

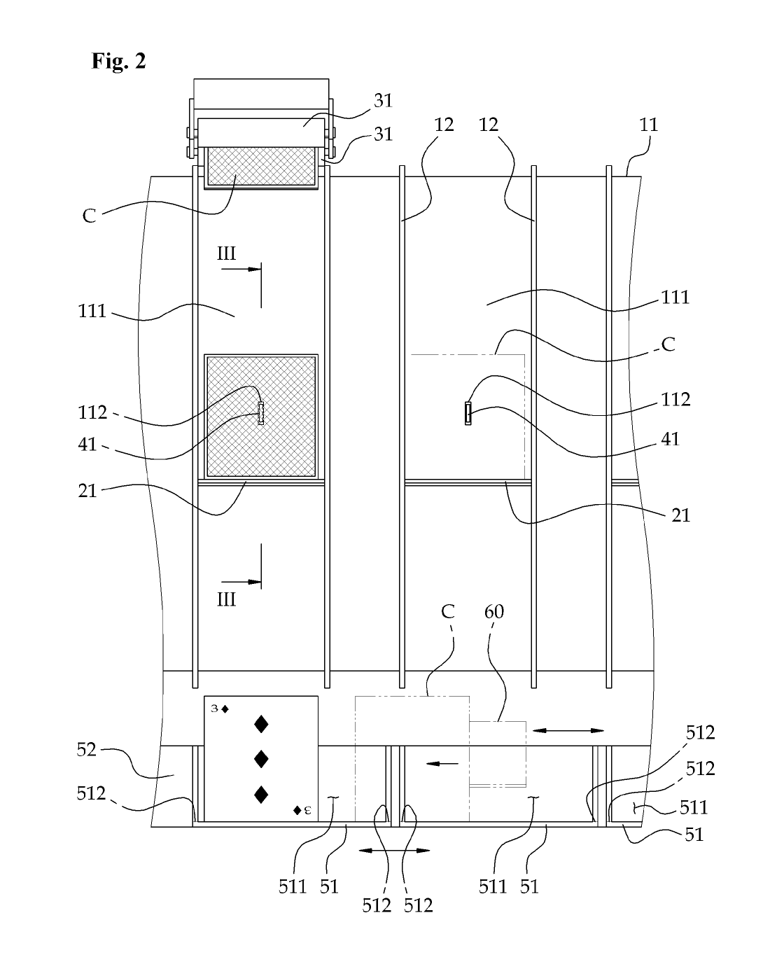

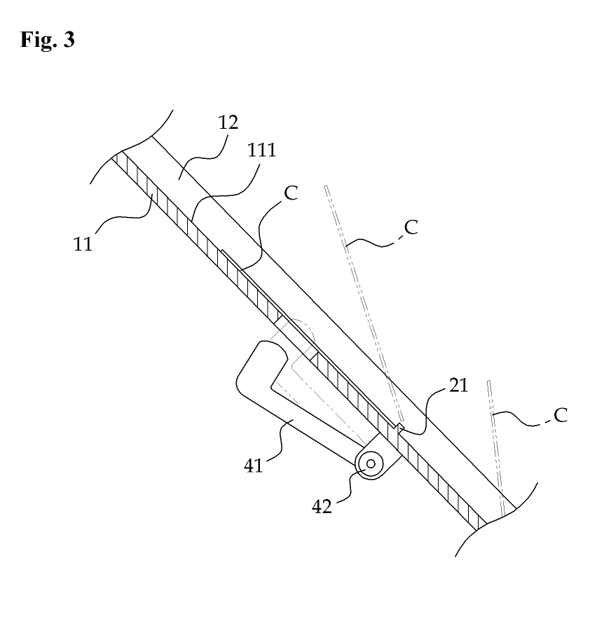

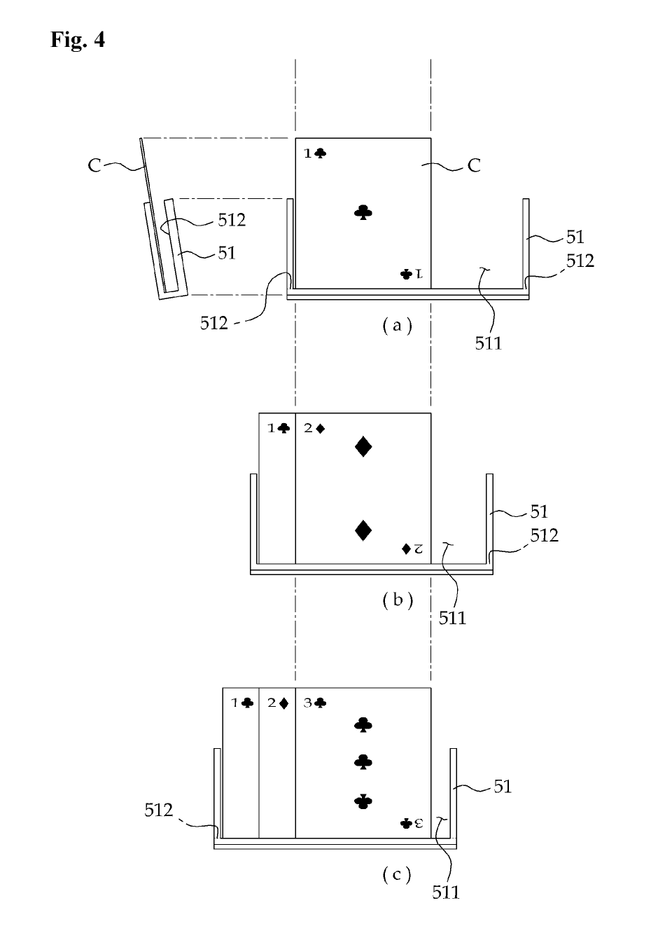

FIG. 1 is a perspective view of an embodiment of a card game machine according to embodiments of the present invention. FIG. 2 is a partial front view of the card slide housing illustrated in FIG. 1. FIG. 3 is a cross-sectional diagram along line of FIG. 2. FIG. 4 illustrates the card receive unit in FIG. 2 in which a plurality of cards are stacked in a state that a portion of distinctive surface of each of cards is recognizable.

Referring to FIGS. 1 to 4, card game machine 100 according to this embodiment is used to play card games such as Blackjack, Baccarat, Poker with cards C. Each card has a distinctive surface with distinctive information and a non-distinctive surface without distinctive information. The distinctive surface has distinctive information such as numbers, suits printed on the surface and the non-distinctive surface has common design and no distinctive information. In this embodiment, trump cards are used as playing cards.

The card game machine 100 has a card slide housing 10, a card stop unit, a card distribute unit, a card drive unit, a card receive unit.

The card slide housing 10 makes the exterior of the card game machine 100. The card slide housing 10 includes sliding plate 11. The sliding plate 11 is in the form of plate and is inclined in the vertical direction. The sliding plate 11 is divided into plural sliders 111 by plural dividing walls 12 formed on the sliding plate 11 on either side of each slider 111. The dividing walls define the slider 111. Pairs of dividing walls 12 on either side of sliders 111 are parallel to each other and are at a distance longer than the width of the cards C, so that when a card C is placed at the upper side of the slider 111, the card C slide down the slider 111 automatically. The number of the sliders 111 can be properly determined. The larger the number of the sliders is the more players can play card games with the card game machine 100. The sliders are parallel to each other and displaced at a pre-determined distance. Plural holes 112 are formed through the sliding plate 11 and the number of the holes 112 is equal to the number of sliders 111.

The card stop unit is installed to stop cards C which are sliding down the sliders 111 at the pre-determined position. The card stop unit includes stoppers 21. Each stopper 21 can be formed at each slider 111 or attached to each slider 111 as separate component. The stoppers 21 are disposed below holes 112 at the same level and protrude from the sliders 111. Each of the stoppers 21 contacts with a card which slides down, especially with the bottom of the card, so that each of the stoppers 21 stops the card at the pre-determined position. The cards are distributed the distinctive surfaces down by the card distribute unit not to reveal the distinctive information of the cards.

The card distribute unit distributes the cards to each of the sliders 111 so that the cards can slide down each of the sliders 111. The card distribute unit installed above the sliders 111 and is movable in the horizontal direction. The card distribute unit distributes a card to one of the sliders selectively during moving in the horizontal direction. The card distribute unit distributes the cards stacked in a cassette one by one. The card distribute unit can be a robot run by motors or actuators or can have the mechanisms disclosed in Japanese patent application publication 2008-12157, 2005-103243 and Korean patent application publication 2006-93694. For example a pair of rollers illustrated in FIGS. 1 and 2 through which cards come out can be used as a card distribute unit.

The card drive unit causes the cards stopped by the stoppers 21 to start sliding down again. The card drive unit has card reversing members 41 and driving units to drive the card reversing members 41.

The number of the card reversing members 41 is equal to the number of the driving units and the number of the card reversing member 41 is equal to the number of the holes 112. Each of the card reversing members 41 is rotatable around the pivot axis 42 engaged at the card slide housing 10. When the card reversing member 41 rotates around the pivot axis 42, the end of the card reversing member 41 is extruded through the hole 112. The end of the card reversing member 41 moves between extruding position as shown in imaginary lines in FIG. 3 and recessing position as shown in solid lines in FIG. 3. The card reversing member 41 is at the recessing position when the card C is supported by the stopper 21. When the card reversing member 41 moves to the extruding position to make the card C slide down, the end of the card reversing member 41 presses the card and the card is flipped over to expose the distinctive surface of the card and slides down the slider 111.

The driving unit is a motor to rotate the card reversing member 41. The driving unit can have a fluid power actuator and links to change linear driving force of the actuator to circular driving force.

The card receive unit is installed to receive cards which have slid down the slider. The card receive unit has plural card receiving housings 51 and a moving member 52 engaged with the receiving housings 51.

The number of the card receiving housings 51 is equal to the number of the sliders 111. Each of the card receiving housings 51 is disposed below each of the sliders 111. The upper side and the front side of each of the card receiving housings 51 are open. And a card receiving part 511 is formed at each of the card receiving housings 51. The card receiving part 511 is a space surrounded by the inner surfaces of the card receiving housing 51. The card which has slid down the slider 111 in a flipped over state is received in the receiving part. The card receiving part receives a card C through the upper side opening and the distinctive information of the card is visible through the front side opening. The card receiving housing 51 is wider than the slider 111. And the card receiving housing 51 has entrance holes 512 at the left and right sides. And the upper sides of the entrance holes are open.

The moving member 52 has a form of plate. The moving member 52 is engaged with the card receiving housings 51. The moving member 52 is installed to move horizontally. The means to drive the moving member 52 can be a stage in a lineal movement driven by an actuator or a motor.

And the card distribute unit, the card drive unit, the card receive unit are controlled by a controller and card game players can control each of the units by the controller. Thus, the card game players can enjoy a game in an active role by controlling the units.

In this embodiment, the moving member 52 is horizontally movable, so that the distinctive information of the plural cards sliding down each of the sliders 511 and stacked in each of the card receiving parts 511 are recognizable unlike the prior arts. Referring to FIG. 4, this effect will be described below. In FIG. 4, only one card receiving housing 51 is shown and other components are removed to simplify the figure. (a), (b) and (c) steps in FIG. 4 show positions of the card receiving housing 51 in operation sequence and the arrangements of the cards received in the card receiving housing 51 at each of the positions.

Before starting a card game, the moving member 52 and the card receiving housing 51 are in the position shown in FIGS. 1 and 2. And if three cards are needed to decide the winner of the card game, card game player receives three cards through the (a), (b) and (c) steps shown in FIG. 4. Other players receive cards through the same steps.

Firstly, a player operates the card distribute unit to distribute a card C to one of sliders 111. When the card is distributed to one of the sliders 111, the card slides down the slider 111 until the card is stopped by the stopper in the state that the distinctive surface of the card is down. Thereafter, when the card reversing member 41 is operated automatically or manually, the card reversing member 41 is extruded out of the slider 111 through the hole and the card is flipped over by the card reversing member 41 to show the distinctive surface of the card and the card slides down the slider into the card receiving part 511 of the card receiving housing as shown in FIG. 4.

In this state that the card C is received in the card receiving part 511, the moving means is moved a little to the left side by a motor or an actuator, before the second card is received in the card receiving part 511. At this time, it is preferable that the displacement of the moving means 52 is set to allow the distinctive information printed edge of the trump card to be recognizable as shown in the (b) step of the FIG. 4.

In this state that the moving means 52 has moved to the left side, the second card can be received in the card receiving part 511 again through the same processes in a flipped over state. At this time, the second card partially covers the first received card to show the distinctive information of the first received card as shown in the step (b) of the FIG. 4.

And to receive the third card, the preceding processes are repeated and the third card is received as shown in the step (c) of the FIG. 4. At this time, three cards are partially overlapped, so that the distinctive information of each of three cards is recognizable. It is shown in the (a), (b) and (c) steps of FIG. 4 that each of the cards drops through the space between imaginary lines.

In the present embodiment, the card game machine enables card game players to always recognize the distinctive information of cards C received in the card receiving part 511 during the game, so that the card game players can enjoy the game.

In the meantime, the card game machine 100 of the present embodiment further comprises a card collect member 60. The card collect member 60 has rectangular shape slightly larger than a card C and moves relative to the moving means 52. Before collecting cards, the card collect member 60 is located on the right of slider 111 which is farthest to the right. And after a card game is over, the card collect member 60 goes through the entrance holes 512 to the left of slider 111 which farthest to the left, while the card collect member 60 pushes cards held in each of the card receiving parts 511 to the left of slider 111 which is farthest to the left. And the cards pushed to the left of slider 111 which is farthest to the left are collected in a collecting box disposed under the moving means 52. The card collect member 60 can have similar mechanism with the moving means 52. Also, the card collect member 60 can have the mechanisms disclosed in Japanese patent application publication 2008-12157, 2005-103243 and Korean patent application publication 2006-93694. Cards collecting process is illustrated in imaginary lines in FIG. 2.

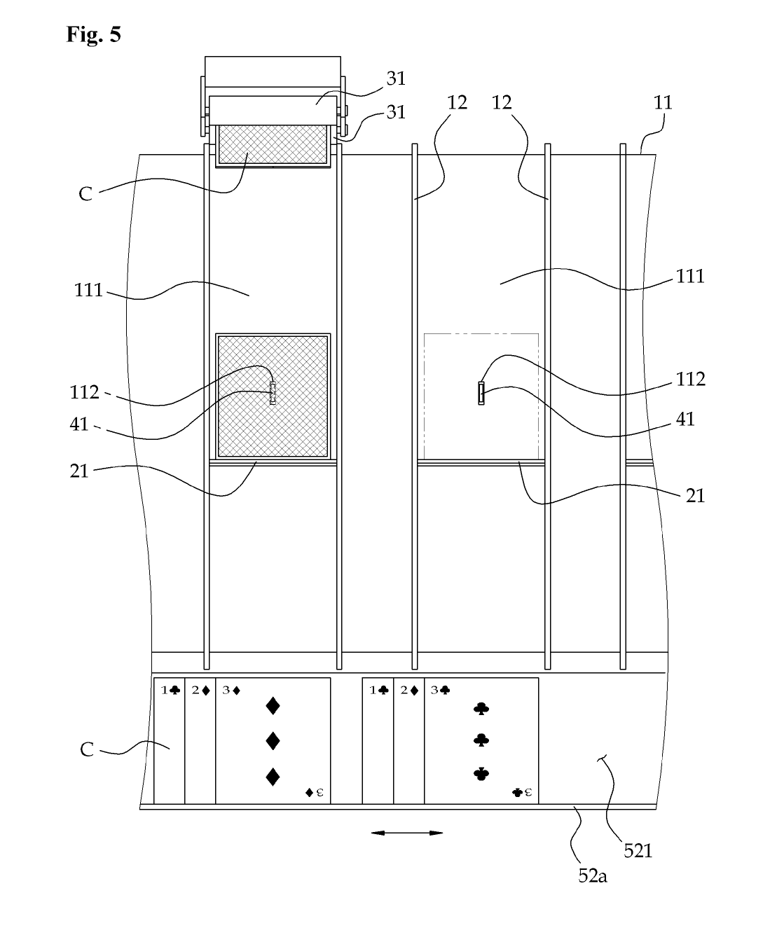

In the present embodiment, the card receive unit have the card receiving housings and the moving means 52 and each of the card receiving housings has the card receiving part. However, it is possible that the card receive unit have a card receiving and moving means as shown in FIG. 5.

The card receiving and moving means 52a is horizontally movable and has an integrated card receiving part 521. The integrated card receiving part 521 can be formed by integrating the card receiving parts 511. Cards C sliding down each of the sliders 111 received by the integrated card receiving part 521 and supported by the inner surfaces of the integrated card receiving part 521.

The card receiving and moving means 52a in which the integrated card receiving part 521 is formed is installed horizontally movable, so that at least a portion of the distinctive information of each of the cards C received in the integrated card receiving part 521 is recognizable as shown in FIG. 4. In the embodiment in FIG. 4, received cards from each slider are separated by physical walls from received cards of neighboring sliders. But in this embodiment, received cards of each of the sliders are not separated by physical walls (for example, the card receiving housing in FIG. 4) from received cards of neighboring sliders.

In this embodiment, the card collect member 60 moves relative to the card receiving and moving means 52a and there is no obstacle such as the card receiving housings.

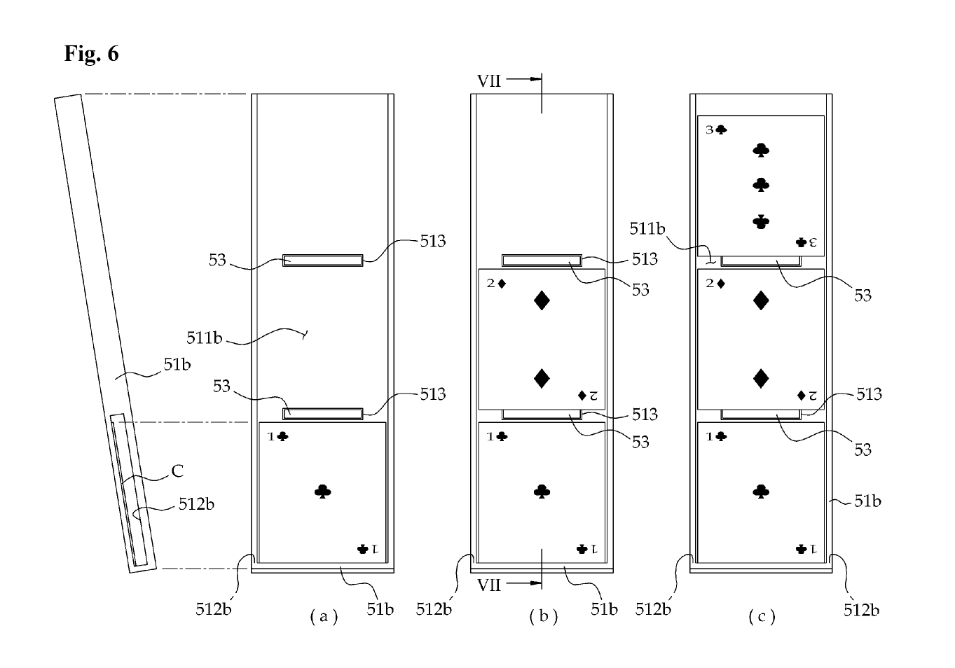

In the meantime, while the moving means of above embodiments are configured to move horizontally, moving means can be configured to move vertically as shown in FIG. 6.

In this embodiment, a card receive unit has plural card receiving housings 51b and card supporters 53.

Each card receiving housing 51b has a card receiving part 511b similar to the card receiving housing 51 of the preceding embodiment except that the width of the card receiving housing 51b is narrower than the card receiving housing 51 of the preceding embodiment. Each card receiving housing 51b is disposed apart from each other in the horizontal direction at regular intervals. Plural through holes 513 are formed apart from each other in the vertical direction in each of card receiving housings.

Multiple card supporters 53 are installed at each card receiving housing 51b. The card supporters 53 are installed to go through each of the through holes 513. Each of the card supporters 53 can alternate between an extruding position and a recessing position. When the card supporter 53 is at the extruding position, at least a part of the card supporter 53 extrudes through the through holes 513, so that a card C which has been flipped over by the card reversing member and starts sliding down the slider to the inner surface of the card receiving part 511b is stopped by the card supporter 53 before the card C reaches the inner surface of the card receiving part 511b. When the card supporter 53 is at the recessing position, the card supporter 53 do not extrude through the through holes 513 at all, so that a card C which has been flipped over by the card reversing member and starts sliding down the slider to the inner side of the card receiving part 511b can reach the inner surface of the card receiving part 511b without contact with the card supporters 53.

In this embodiment, when the card game machine is operated as below, the cards are separated from each other vertically, so that distinctive information of each of the cards is always recognizable as shown in FIG. 6.

In the initial state, each card supporter 53 is positioned at the recessing position. In this state, a card C slides down without contact with each of the card supporters 53 and reaches the inner side of the card receiving part 51b which defines the card receiving part 511b. Thereafter, when the bottommost card supporter 53 in the card receiving housing 51b is positioned at the extruding position to hold the second card, and the second card is distributed to slide down toward the card receiving part 511b, the bottom side of the second card contacts with the bottommost card supporter 53 and is stopped by the bottommost card supporter 53. Thus, the first card and the second card are separated from each other vertically, and the distinctive surfaces of the first card and the second card are entirely visible. Furthermore, the third card can be received by the same procedure except that the card supporter 53 just above the bottommost card supporter 53 is positioned at the extruding position. In this way, cards can be separated vertically for distinctive information of a plurality of cards to be recognizable.

And in this embodiment, when cards are needed to be collected, all of the card supporters 53 are to be positioned at recessing position before the card collect member 60 moves through entrance holes 512b.

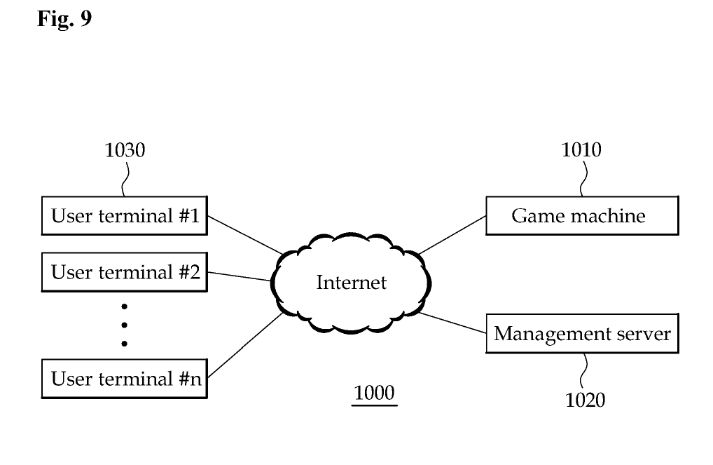

Hereinafter, a process of playing card games in a remote site is described referring to FIGS. 9 to 13. FIG. 9 shows a configuration of a remote game system 1000 according to embodiments of the present invention.

As shown in FIG. 9, the remote game system 1000 includes a game machine 1010 performing above described operations, and a management server 1020 broadcasting the operations of the game machine 1010 to remote players live in real time, and a plurality of user terminals 1030 for the remote players to participate in games.

In FIG. 9, the game machine 1010, the management server 1020 and the user terminals 1030 are interconnected through the interne. The game machine 1010 and the management server 1020 can be directly connected for maintenance and management.

The game machine 1010 is an automated machine to play specific games such as Roulette, Baccarat, Dice, Blackjack etc. The game machine 1010 runs a game automatically according to each game rule and perform game operation according to commands from remote players.

The management server 1020 broadcasts the current state of a game to remote players and sends the game commands of the remote players to the game machine 1010. The management server 1020 transmits operating images of the game machine 1010 to the user terminals 1030 live in real time and sends the game commands from the user terminals 1030 to the game machine.

The user terminals 1030 show the operating images of the game machine 1010 on displays of the user terminals 1030. Remote players participate in a game by inputting game commands as they see the operating images of the game machine on displays of the user terminals 1030.

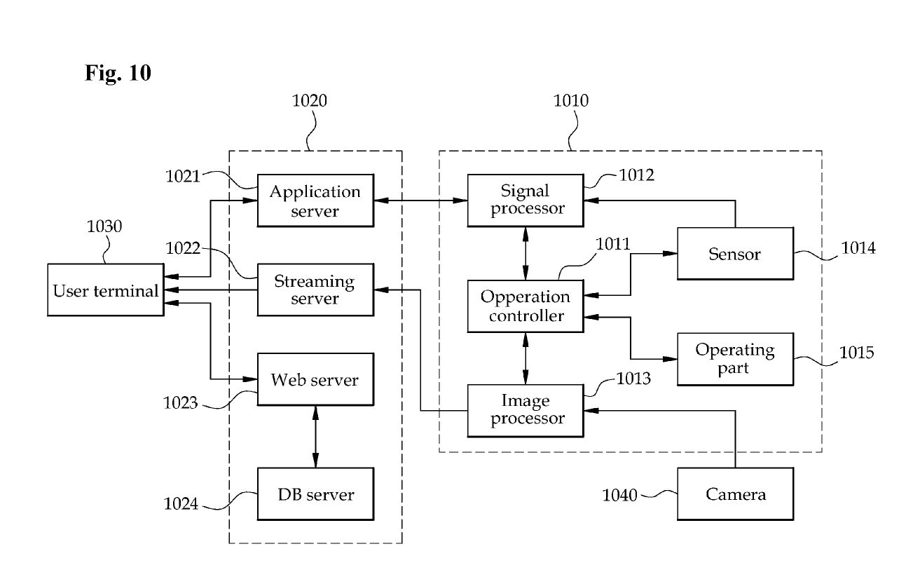

FIG. 10 shows configurations of a game machine 1010 and a management server 1020 of the remote game system 1000. As shown in FIG. 10, the game machine 1010 has an operation controller 1011 to control the operation of the game machine 1010, a signal processor 1012 receiving and processing information regarding operation of the game machine 1010 and transmitting an processed information to an application server 1021, an image processor 1013 processing video images of game machine 100 taken by an external camera 1040 and transmitting the processed video images to a streaming server 1022, a sensor 1014 sensing the distinctive information of game tools (for example cards, balls, dices etc.) and a operating part 1015 consisting of several mechanisms to perform motions of the game machine 1010.

The operation controller 1011 controls the whole operations of the game machine 1010. The operation controller 1011 drives the operating part 1015 according to a rule of a specific game and controls motions of the mechanisms of the game machine 1010.

The signal processor 1012 receives the operating information of the game machine 1010 from the operation controller 1011 and produces operation state signals. In the meantime, the signal processor 1012 receives the images of the game tools and produces an image recognition signal including the distinctive information of the game tool (a suit of a card, a number on a dice, a number on a ball) used in the games. The signal processor 1012 transmits the operation state signal and the image recognition signal to the application server 1021 during operation of the game machine.

Moreover, the signal processor 1012 receives and processes the game commands input through the user terminals 1030 and transmits the game commands to the operation controller 1011. The operation controller 1011 controls the operating part 1015 according to the game commands.

The camera 1040 is installed about game machine 100 to take the video images of the game machine in operation and the image processor 1013 processes the video images from the camera 1040 and transmits the processed video images to the streaming server 1022.

The sensor 1014 senses the game tools used in game machine 1010 and takes the distinctive information images of the game tools for image recognition of the game tools. The distinctive information images of the game tools taken by the sensor 1014 is input to the signal processor 1012 and the signal processor 1012 processes the distinctive information images of the game tools and produces the image recognition signal.

The operating part 1015 is a part performing motions such as distributing cards, rolling a dice. The operating part 1015 performs specific game motions according to the command of the operation controller 1011.

As shown in FIG. 10, the management server 1020 has the application server 1021 managing the process at the user terminals 1030 based on the operation state of the game machine 1010, the streaming server 1022 receiving the video images from the game machine 1010 and transmitting the video images to the user terminals 1030 live in real time, a web server 1023 providing functions related to games played on the web, and a database server 1024 storing various data.

The application server 1021 receives the operation state signal of the game machine 1010 and the image recognition signal from the signal processor 1012, and enables players to play a game at the user terminals 1030. And the application server 1021 receives various game commands input through the user terminals 1030 and transmits the various game commands to the game machine 100.

The streaming server 1022 receives the video images of the game machine from the image processor 1013 and transmits the video images to the user terminals 1030 in a streaming fashion. The user terminals 1030 display the video images of the game machine 1010 transmitted from the streaming server 1022 live in real time.

The web server 1023 provides the necessary functions for the players to play the games. When the user terminals 1030 are connected to the web server 1023, the players can register, log-in, cost paying, download game software, and reserve a game etc. by the user terminals 1030.

The database server 1024 stores various information such as user information, log-in information, transaction information, game software information, and web page information. When the user terminals 1030 are connected with the game server, the web server 1023 transmits the information of the database server 1024 to the user terminals 1030 and transmits the data from the user terminals 1030 to the database server 1024.

The user terminals 1030 are personal computers or notebooks equipped by remote player to play games. The players need to download the game software from the web server 1023 and install the game software to the user terminals 1030. By means of operation of the software, the user terminals 1030 process the game, exchanging the date with the application server 1021.

The user terminals 1030 receive the video images of the game machine 1010 from the streaming server 1022, and receive operation state signals of the game machine 1010 and the image recognizing information related to the game tools from the application server 1021, and display the video images of the game machine 100 live in real time, and display the state of game progress and graphical images of the game tools recognized by the signal processor 1012.

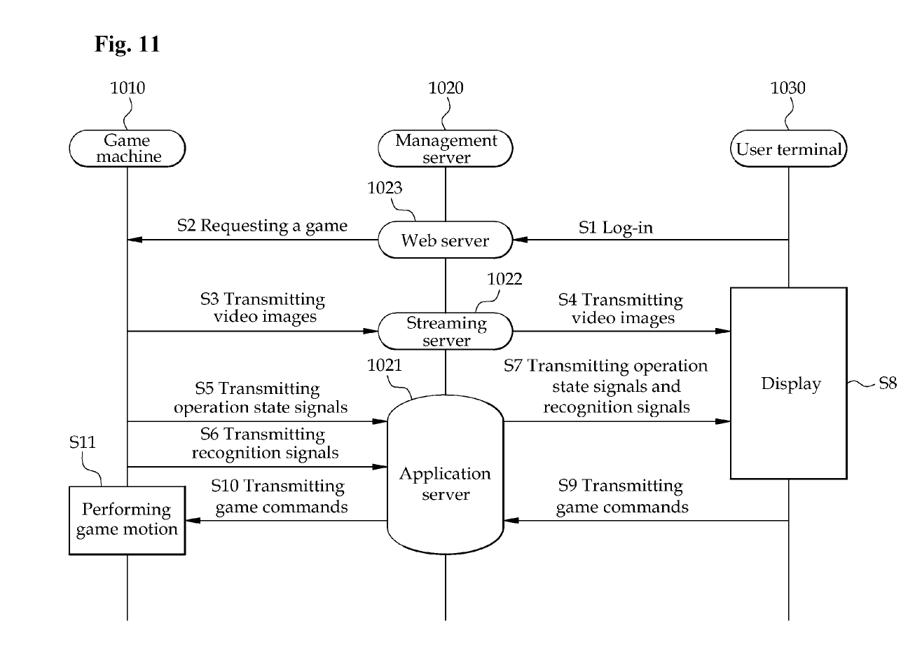

FIG. 11 shows a signal flow of a remote game system according to embodiments of the present invention. As shown in FIG. 11, firstly, the user terminal 1030 is connected with web server 1023 by log-in (S1). When the user terminal 1030 requests for a specific game, the web server 1020 requests a game from a game machine 1010 for playing the requested game (S2).

The game machine 1010 requested the game from the web server 1023 transmits the operating video images of the game machine 1010 to the streaming server 1022 (S3). When the streaming server 1022 receives the video images of the game machine 1010 from game machine, the streaming server 1022 transmits the video images to the user terminal 1030 in a streaming fashion (S4).

And the game machine 1010 transmits the operation state signal representing the operation state of the game machine 1010 and the image recognition signal including the distinctive information of the game tools to the application server 1021 (S5, S6). After receiving the operation state signal and the image recognition signal from the game machine 1010, the application server 1021 processes the operation state signal and the image recognition signal and transmits them to the user terminal 1030 (S7).

The user terminal 1030 receives the video images of the game machine 1010 from the streaming server 1022, and receives the operation state signal of the game machine 1010 and the distinctive information related to the game tools from the application server 1021, and displays the game images on the monitor (S8). The user terminal 1030 displays the video images of the game machine 1010 live in real time, and display the graphical images of recognized game tools at the same time.

The progress of the game can be known by the game images displayed on the monitor. The game commands input with a keyboard or a mouse at proper timing are transmitted to the application server 1021 (S9). When the application server 1021 receives the game commands from the user terminal 1030, the application server 1021 transmits the game commands to the game machine 1010 (S10).

When the application server 1021 receives the game commands from the application server 1021, the game machine 1010 performs the game operations in accordance with the commands (S11). As the game machine 1010 performs the game operations, the operation state of the game machine 1010 and the distinctive information of the game tools are transmitted through the application server 1021 to the user terminal 1030. During the game, the steps S3 to S11 are operated repetitively.

The game process in the remote game system 1000 according to embodiments of this invention will be described. Blackjack will be used as an example to describe the game process more specifically.

Blackjack is a card game using card (trump). A player who brings total value of the cards closer to 21 than a dealer wins the game. At the beginning of each round, single cards are dealt to each of players clockwise from the dealer's leftmost position, followed by a single card to the dealer, followed by an additional card to each of the positions in play. So the dealer and the players are dealt initial two cards. On their turn, the players can choose whether to take a card (Hit), to end their turn without taking a card (stand). The players try to create card totals which will turn out to be higher than the dealer's hand, but without exceeding 21. Each player places their bets against the dealer. Each player wins their bets if its hand is higher than the dealer's. When Blackjack is played in the remote game system 1000 of embodiments of this invention, the game machine is corresponding to a dealer and the user terminal to a player.

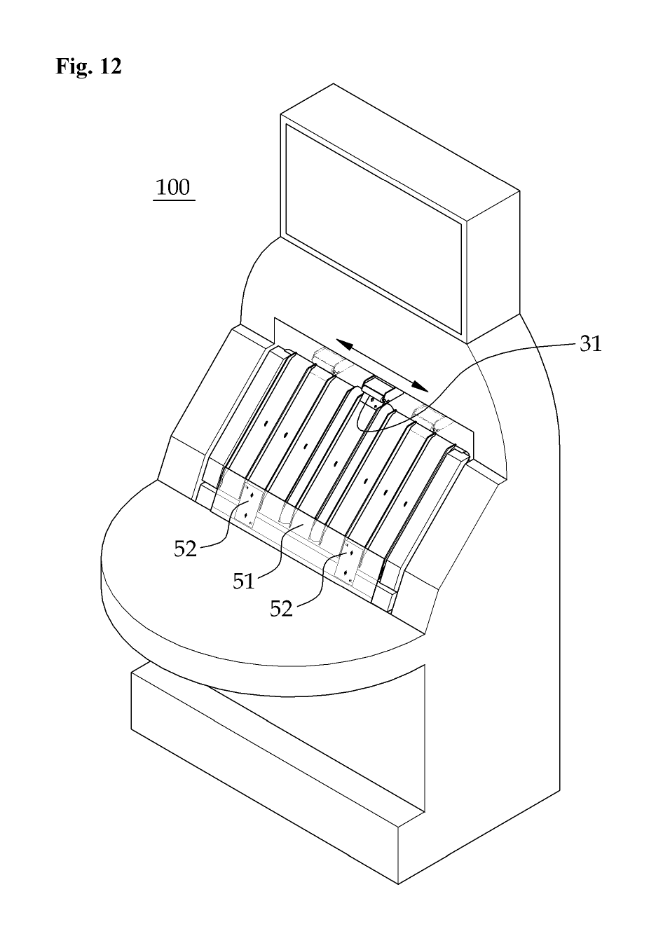

FIG. 12 shows a Blackjack game machine 100. As shown in FIG. 12, the Blackjack game machine 100 has a dealer card receive part 51, a player card receive part 52 and a card distributor 31. The card distributor distributes the cards to the dealer card receive part 51 or the player card receive part 52, moving horizontal direction in accordance with game rules and game commands. In this way, the Blackjack game machine 100 automatically distributes the cards to the dealer and the players respectively.

The video images of the game operation of the Blackjack game machine 100 are transmitted to the user terminal 1030 live in real time. The user terminal 1030 displays the video images of the game operation of the Blackjack game machine 100 on the monitor. The remote player seeing the monitor can enjoy Blackjack.

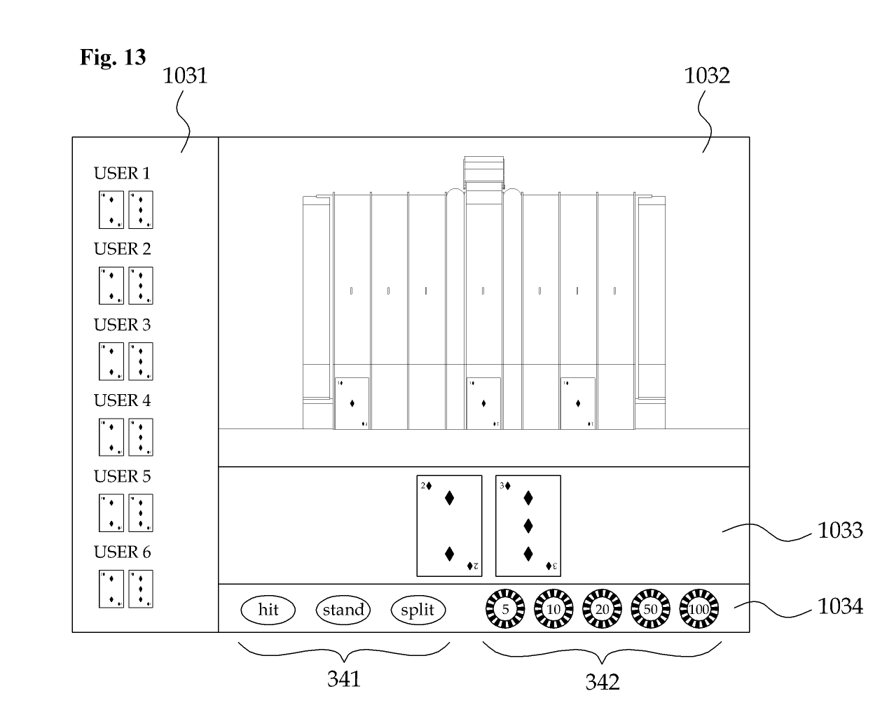

FIG. 13 shows a screen of Blackjack game displayed on the user terminal 1030. As shown in FIG. 13, the screen of Blackjack game is divided into a first region 1031 showing the status of the player, a second region 1032 showing the video images of the Blackjack game machine 100 in operation, a third region 1033 showing the graphical images of cards being used in the Blackjack game machine 100 and a fourth region 1034 showing icons and buttons relating to game commands.

In the first region 1031, the number of players, IDs of players and the graphical images of the cards of each player are shown. In the second region 1032, the operation state of the Blackjack game machine 100 is shown live in real time. The players can see the Blackjack game machine 100 distributing the cards to the dealer and the players on the second region 1032. In other words, the players can see cards from the card distributor 53 going into the dealer card receive part 51 or the player card receive part 52.

The graphical images of cards received by dealer card receive part 51 or the player card receive part 52 are shown in third region 1033 as described above. In the third region 1033, the received cards images are shown graphically. The player can identify his cards and dealer's cards by seeing the graphical images of cards shown in the third region 1033.

In FIG. 13, the graphical images of recognized cards are shown in the third region 1033. But the graphical images of recognized cards can be shown in the second region 1032 with the video images of the Blackjack game machine. The graphical images of recognized cards of the dealer can be shown in the second region 1032 with the video images of the Blackjack game machine and the image recognized cards of the player can be shown in the third region 1033, or the graphical images of recognized cards of the dealer and the player can be shown in the second region 1032 without the third region 1033.

In the fourth region 1034, the buttons and icons for game commands inputting is shown. The players can control the Blackjack game machine 100 by pushing the buttons 341 and bet by pushing or dragging the coin icons 342.

When the player pushes the hit button, the Blackjack game machine 100 deals another card to the player. When player pushes the stand button, the Blackjack game machine 100 deals no more cards. When player pushes the split button, the Blackjack game machine 100 draws a further card on each split card.

While certain embodiments of the present invention have been described hereinabove, the present invention shall not be limited thereto. It will be apparent to those skilled in the art that various changes and modifications may be made without departing from the scope of the invention defined in the claims.

What is claimed is:

1. A method of providing an online card game service, the method comprising:
providing a card dispenser configured to dispense a plurality of cards to a card placing station and maintain the a plurality of cards in the card placing station, wherein each of the cards comprises a distinctive surface comprising at least one mark configured to make it distinctive from the other cards;
operating the card dispenser to dispense a first one of the plurality of cards to the card placing station and maintain the first card in the card placing station;
shooting video frames of the card dispenser in operation thereby generating video signals;
streaming, by an online game server, the video signals to a user's terminal connected to the online game server thorough a network so as to display the video frames of the card dispenser in operation;
sensing the at least one mark of the first card to identify the first card and generate information associated to the first card; and
transmitting, by the online game server, the information to the user's terminal so as to display an image representing the first card on the user's terminal while the user's terminal displays the card dispenser.

2. The method of claim 1, wherein the information comprises image data representing the first card.

3. The method of claim 1, wherein the information is configured to cause the user's terminal to process image data stored in the user's computer so as to display the image representing the first card on the user's computer.

4. The method of claim 1, wherein the information is configured to cause the user's terminal to display the image representing the first card on the user's computer while the dispenser is dispensing the first card to the card placing station.

5. The method of claim 1, wherein the information is configured to cause the user's terminal to display the image representing the first card on the user's computer while the dispenser maintaining the first card in the card placing station.

6. The method of claim 1, wherein the at least a mark comprises one selected from the group consisting of characters, numbers, symbols, drawings, pictures and photos.

7. The method of claim 1, wherein the first card is sensed during dispensing the first card or after dispensing the first card to the card placing station.

8. A method for playing a card game remotely using a system comprising a card game machine having a card distribute unit which distributes cards onto a plurality of sliders, a sensor for taking distinctive information images of distributed cards, a signal processor for producing an image recognition signal including the distinct information of cards and transmitting the image recognition signal, a card stop unit to stop cards from sliding down each of the sliders at a predetermined position, and a card drive unit which causes the cards that have been stopped by the card stop unit to start sliding again down the sliders in a flipped over state;
a streaming server connected to the interne for transmitting video images of the operation state of the game machine in a streaming fashion;
an application server connected to the internet for receiving the image recognition signal from the signal processor of the game machine and transmitting the image recognition signal;
user terminals receiving the video images of the operation state of the game machine form the streaming server and the image recognition signal from the application server, displaying the video image and graphical images of cards;
wherein the method comprises,
transmitting the video images of the operation state of the game machine from the streaming server to the user terminals live in real time;
transmitting the image recognition signal of a card from the application server to the user terminals, after the card being flipped over by the card drive unit and sliding again down a slider;
displaying the video images of the operation state of the game machine and the graphical image of the card on the user terminals.
